(19) United States
(12) Patent Application Publication
(10) Pub. No.: US 2005/0001901 A1
(43) Pub. Date: Jan. 6, 2005

(54) Camera system for a motor vehicle

(76) Inventors: Helmuth Eggers, Ulm (DE); Gerhard Kurz, Wendlingen (DE); Juergen Seekircher, Ostfildern (DE); Thomas Wohlgemuth, Aichtal (DE)

Correspondence Address: PENDORF & CUTLIFF, 5111 Memorial Highway, Tampa, FL, 33634-7356, US

(21) Appl. No.: 10/885,360

(22) Filed: Jul. 6, 2004

(30) Foreign Application Priority Data
Jul. 3, 2003 (DE) 103 29 900.9

(51) Int. Cl. H04N 9/47

(52) U.S. Cl. 348/118

(57) ABSTRACT

In a camera system to be installed in a passenger compartment of motor vehicle, a camera (3) is surrounded by a housing (7) and is oriented towards the windshield (1) of the passenger compartment. Between the camera (3) and the windshield (1) a shield (11) is provided, which is moveable between a closed position in which the camera (3) is shielded against scatter light from the passenger compartment and an open position in which access may be had to the front lens (4) of the camera (3) and the area (6) of the windshield lying in the field of view of the camera (3).

### BACKGROUND OF THE INVENTION

1. Field of Invention

The present invention concerns a camera system to be mounted in the passenger compartment of motor vehicle. This type of camera system has been proposed in recent years in order, for example, to continuously monitor the environment of the vehicle while driving, and to record images taken at this time in a recording media, which media written over after a short storage interval, so that after the vehicle is involved in an accident images of the environment are available covering the last seconds prior to the accident, which images can be used in order to clear up, for example, the cause of the accident and to assign responsibility. Another application of this type of camera system is in systems for automatic assistance of the driver, who on the basis of images supplied by such a camera system is able, for example, to judge the distance to a preceding vehicle and to more rapidly adapt the own speed of the vehicle and the spacing than the driver could do alone, or which system is able to recognize those exceptional situations, such as for example the departure of the vehicle from the lane during a momentary falling sleep of the driver, and to produce a warning signal in order to wake the driver.

2. Related Art of the Invention

It is important for the effectiveness of such a camera system that the camera has an unobstructed field of view. In order to prevent obstruction of the camera by dirt on the windshield behind which the camera is located, it is proposed in DE 43 29 983 A1 to place the camera in an area of the windshield of the vehicle which is cleaned by windshield wipers. An obstruction of the field of view of the camera by a fogging from inside can, however, not be prevented in accordance with the technique disclosed in this document.

U.S. Pat. No. 5,096,287A1 teaches a camera system in a motor vehicle, the camera mounted on the arm which carries a rear view mirror. The camera is directed forwardly to take pictures through the front windshield of the motor vehicle and a backlight shield or boot is provided between the camera and the windshield, with the front edge of the shield flush against the inside of the windshield. In order to prevent fogging of the windshield in the field of view of the camera, a forced air ventilation channel passes through the camera bracket, through which air flows into the space between the camera, backlight shield and windshield, which air subsequently flows out of ventilation holes in the backlight shield. This solution is undesirably complex to implement, since the introduction of forced air occurs through conduits built into the roof of the vehicle. Further, it does not provide immediate relief when the windshield is fogged in the field of view of the camera. Further yet, it is not possible for the driver to determine whether the field of view of the camera is clear, since the backlight shield conceals the field of view of the camera in the vicinity of the windshield from the view of the driver.

### SUMMARY OF THE INVENTION

It is the task of the present invention to provide a camera system for installing in the passenger compartment of a motor vehicle, wherein on the one hand the camera is protected from interfering reflections from the passenger compartment, while on the other hand it should be possible for the driver to easily check that the field of view of the camera is free of impediments and, if present, for him to remove these.

This task is solved by a camera system with the characterizing features of claim 1. The moveability of the shield makes it possible for the driver to expose, at any time, the area of the windshield through which the camera views towards the outside in order to check whether the field of view of the camera is unimpeded and, when necessary, to remove precipitation from this area of the windshield or from the front lens of the camera. When the shield, following such an operation, is returned to its closed condition, then the camera can operate without interference from reflections from the passenger compartment.

In a first embodiment of the invention the shield is pivotable between its two positions. This shield is preferably coupled to the camera housing, which for its part is rigidly mounted. It is however also conceivable that the shield is pivotable back and forth together with the camera housing as a integral unit.

Since the camera is a safety related device for the vehicle, and as such must possess a high degree of reliability, it is considered advisable to employ as the linkage mechanism for the shield a friction hinge, which imparts to the driver an impression of high value workmanship consistent with the quality necessary of the camera.

In a second embodiment the shield is slideable between two positions, and for simplicity it is preferred that the shield and the housing are slideable as a unit.

An air channel is preferably formed between the housing and the camera, through which air can flow, which entrains the exhaust heat from the camera and thereby cools the camera.

In order to emit the warmed air and/or to allow the inflow of fresh air, the housing is preferably provided with a ventilation opening. Likewise, for ventilation, a gap is preferably formed between the windshield and one of the edges of the shield facing the windshield.

It is frequently the case that the edge area of the windshield of a motor vehicle is provided with a light-impermeable coating, in order to conceal underlying areas, for example, the adhesives or molding of the windshield. A light impermeable area in a windshield can be used to advantage, by leaving a transparent window open, through which the camera can view and which in the closed or engaged position of the shield is covered over thereby. When the edge of the window is completely covered by the shield, then any tolerances or imperfections during installation of the camera are well hidden. When the light impermeable area is black, then it simultaneously works as a stray light shield for the camera.

### BRIEF DESCRIPTION OF THE DRAWINGS

Further features and advantages of the invention can be seen from the following description of illustrative examples with reference to the attached figures. There is shown:

FIG. 1 a schematic section through an inventive camera system according to a first embodiment, with closed shield;

FIG. 2 the camera system according to FIG. 1, with open shield;

FIG. 3 a second embodiment of the inventive camera system with a section analogous to FIGS. 1 and 2;

FIG. 4 a third embodiment of the inventive camera system with a section analogous to FIGS. 1 and 2;

FIG. 5 a section through the camera system of FIG. 4 along line V-V of FIG. 4;

FIG. 6 a fourth embodiment of the inventive camera system with a section analogous to FIGS. 1 and 2; and

FIG. 7 a section through the camera system of FIG. 6 along line VII-VII of FIG. 6.

### DETAILED DESCRIPTION OF THE INVENTION

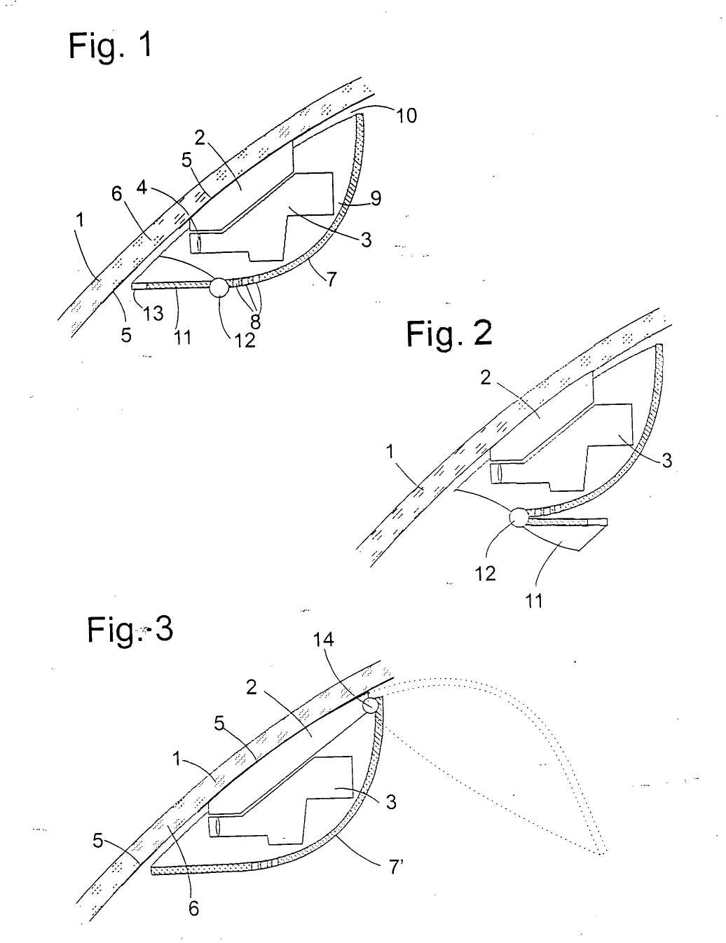

FIG. 1 shows a schematic section through a camera system according to a first embodiment of the invention. A mounting bracket 2 is adhered to a windshield 1 of a motor vehicle, to which in turn an electronic camera 3 is secured. The camera 3, since it is so well known, is shown essentially schematically by its outline; basically it's front lens 4 is shown. The windshield 1 is, for its part, provided on its inner side with a black coating, which hides the camera system from the outside; essentially only a transparent window 6 is left free, through which the camera 3 can see the outside.

Towards the passenger compartment the camera 3 is covered by a shell-like housing 7, in the lower area of which a plurality of holes 8 are formed, which permit the inflow of fresh area into the inside of the housing 7 below the camera 3. The mounting bracket 2 is broader than the camera 3 itself in the direction transverse to the section plane of FIG. 1, and includes engagement means on (not shown) side flanks, which cooperate with complementary engagement means of the housing 7, in order to hold the housing 7. The camera 3 itself does not contact the housing 7, such that along its backside and on both side-flanks channels 9 extend between the camera 3 and the housing 7, through which air entering the housing 7 through the holes 8 flows along the camera 3, warms itself, and finally exits from the gap 10, through which the housing 7 is separated from the windshield 1.

In a front lower area of the housing 7 a shield 11 is linked to the housing 7 via a hinge 12. The shield 11 appears, viewed from outside, to be a flush continuation of the housing 7. It is provided, on the windshield 1 facing edge, with an approximately finger-wide and finger-deep cutout 13, which makes it possible for the driver to grasp behind the shield and to flip it open when the driver would like to check whether the window 6 is clear or whether condensation must be wiped from the windshield 1. The hinge 12 is friction limited, in particular, it exhibits friction to the extent that on the one hand the folding open is not made difficult thereby, however, it remains fixed in any position in which it is released, even at positions between the closed position shown in FIG. 1 and the open position shown in FIG. 2.

In order not to have to make the friction of the hinge 12 too strong, and yet to reliably prevent an opening of the shield 11 even during bumpy driving, a magnetic closure means can be provided, which supports shield 11, keeping it in its closed position.

In the embodiment according to FIG. 3 the housing 7′ and the shield 11′ are fused into a single piece, that is, the shield 11′ is a single piece of the housing 7′ projecting in front of the housing 7′ beyond the front lens 4 or the body of the camera 3, covering over the viewing window 6 of the camera, and the housing 7′ as a single piece is hinged to the mounting bracket 2 via a hinge 14 in the upper rear edge area. Thus the housing 7′ is pivotable out of its closed position shown with a solid line into an open position as shown, for example, in dashed lines in FIG. 3, in which open position not only the window 6 but also the camera 3 is exposed.

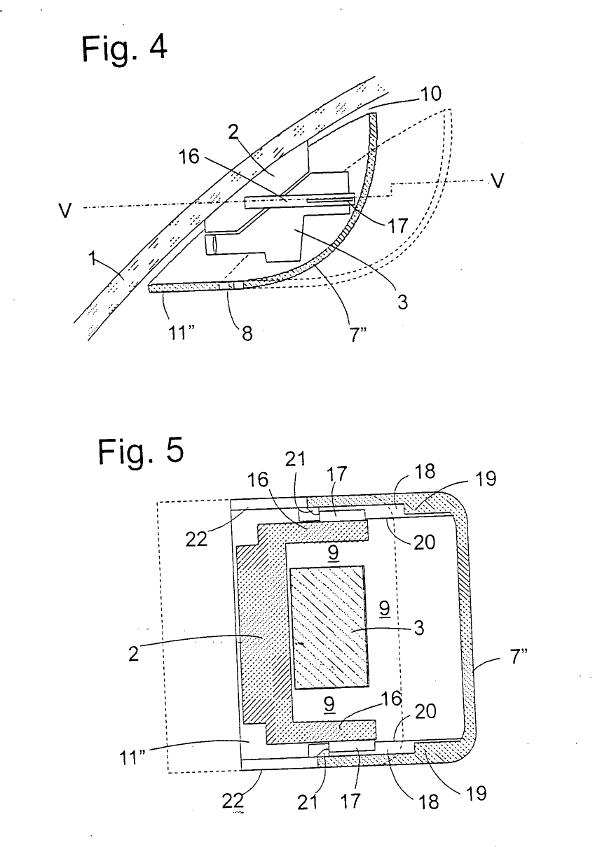

FIG. 4 shows a third embodiment of the inventive camera system in a section analogous to FIGS. 1-3, wherein the housing 7″, which again together with the shield 11″ is fused into a single piece, is slideable on tracks between a closed position shown with continuous lines and an open position shown with dashed lines. These tracks are formed by two bracket arms 16 which, beginning from the mounting bracket 2, engage about two sides of the camera 3 and respectively have an outwardly oriented spring 17. The two springs 17 are, as can be seen in the horizontal section of FIG. 5, guided in the horizontal groove 18, which are respectively formed by two ribs 19, 20 projecting from the side flanks of the housing 7′. The two grooves 18 are respectively terminated by an abutment projection 21 at the front edge of the housing 7″ facing towards the windshield 1 which in the open position shown with solid lines in FIG. 5 respectively abut against one edge of the springs 17 and thus prevent a complete pulling off the housing from the mounting bracket 2. During mounting of the housing 7″ to the mounting bracket 2 the side flanks 22 of the housing are spread apart for a short period, such that the engagement projections 21 can pass the springs 17. In appropriate manner the housing 7″ can also be dismounted, in order to have access to the camera 3 as necessary. Under normal conditions the housing 7″ when in the open position however allows access only to the window 6 and the front lens 4.

Here also, as can be clearly seen in the section according to FIG. 5, the camera 3 is surrounded on three sides by flow channels 9, in which air entering through the holes 8 at the lower side of the housing 7′ can flow along the camera 3 and finally can escape through the gap 10 between the housing 71 and windshield 1.

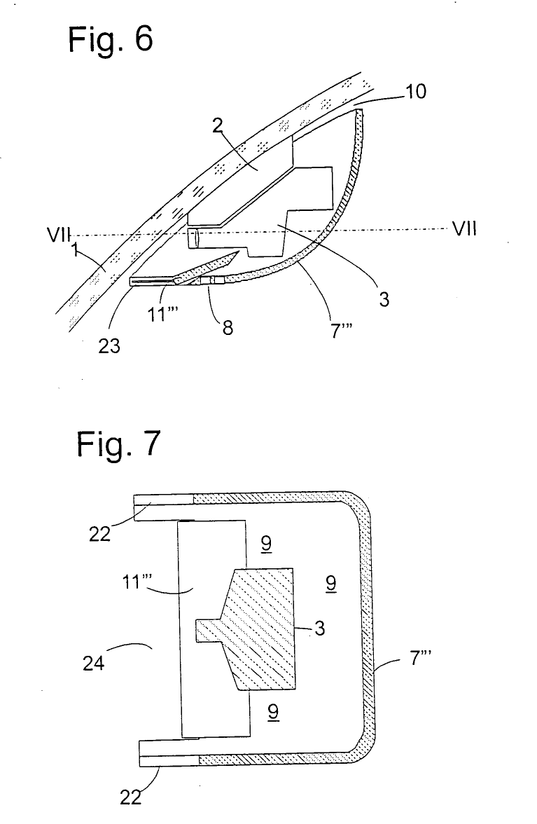

FIGS. 6 and 7 show a fourth embodiment of the invention in two sections analogous to those of FIGS. 4 and 5. Housing 7″′ and shield 11″′ are here, again, formed as two parts, and this namely in the manner that the plate shaped shield 11″′ is guided in grooves 23 of a section 24 of the housing slidable between a (not shown) closed position, in which it is flush with and closes the cutout 24, and an open position shown in the Figs., in which it permits access to the window 6 and the front lens of the camera 3.

1-10. (cancelled)

11. A camera system adapted for installing in a passenger compartment of a motor vehicle, wherein a camera (3) surrounded by a housing (7, 7′, 7″, 7″′) is provided on a windshield (1) of the passenger compartment and wherein a shield (11, 11′, 11″, 11″′) is provided between the camera (3) and the windshield (1), wherein the shield (11, 11′, 11″, 11″′) is moveable between a closed position, in which the camera (3) is shielded from scatter light or back light from the passenger compartment, and an open position, in which access is provided to the front lens (4) of the camera (3) and an area (6) of the windshield in the field of view of the camera (3).

12. A camera system according to claim 11, wherein the shield (11, 11′) is pivotable between its two positions.

13. A camera system according to claim 12, wherein the shield (11) is linked to the housing (7) of the camera system by an articulated linkage.

14. A camera system according to claim 13, wherein the shield (11) is connected to the housing (7) by a frictional hinge (12).

15. A camera system according to claim 11, wherein the shield (11″, 11″′) is slideable between two positions.

16. A camera system according to claim 15, wherein the shield (11″) and the housing (7″) are slideable together as a unit.

17. A camera system according to claim 11, wherein at least one air channel (9) is formed between the housing (7, 7′, 7″, 7″′) and the camera (3).

18. A camera system according to claim 17, wherein the housing (7, 7′, 7″, 7″′) is provided with ventilation openings (8).

19. A camera system according to claim 11, wherein a gap (10) is formed between the windshield (1) and an edge of the housing (7, 7′, 7″, 7″′) facing the windshield (1).

20. A camera system according to claim 11, wherein a light impermeable, preferably black, area (5) is formed on the windshield (1), and that the shield (11, 11′, 11″, 11″′) in its closed position shields a transparent window (6) formed in the light impermeable area (5).
